(19) United States
(12) Patent Application Publication
(10) Pub. No.: US 2008/0139253 A1
(43) Pub. Date: Jun. 12, 2008

(54) Presentation Of An Operator Indicator

(75) Inventors: Pascal Di Girolamo, La Ciotat (FR); Frederic Faure, Cassis (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 11/815,171

(22) PCT Filed: Jan. 12, 2006
(86) PCT No.: PCT/EP2006/050173

§ 371 Date: Jul. 31, 2007

(30) Foreign Application Priority Data
Feb. 2, 2005 (FR) 0501173

(51) Int. Cl. H04B 1/38

(52) U.S. Cl. 455/567

(57) ABSTRACT

In order to request the presentation of an operator indicator in a user's terminal having a first mobile terminal connected to a first cellular radiocommunications network, the operator is related to a second mobile terminal whose call number is stored in the user's terminal and is transmitted therefrom to a server of the first network. The server compares the transmitted call number with call numbers of the first network mobile terminal contained in a first list, in such a way that it is enabled to read the operator indicator corresponding to the transmitted call number. A module in the form of a UICC card stores the indicator and submits it to the user for informing the user whether the call number belongs to the first network or belongs to another network.

The present invention relates to a method for presenting an operating indicator indicating the operator of a call number in a user terminal. The invention also relates to the presentation of a validity indicator indicating whether the call number is valid.

Currently, cellular radiocommunications network operators are seeking to offer ever-increasing amounts of information and of services to their users. The cost, to a caller user, of communicating with a called mobile terminal depends on the cellular radiocommunications network which the called terminal is attached to. At a time when mobile terminal number portability between operators is recommended so that each user can keep the same call number when they change operators, it is no longer possible to evaluate the cost of a call by determining the network corresponding to the call number of the called terminal by means of a specific network identifier included in the call number.

Therefore there exists a need for an operator indicator associated with a call number in a terminal so that the user of said terminal can decide whether or not to communicate with the terminal designated by said call number.

An object of the invention is to provide a new service relating to a phonebook to a user having a first mobile terminal attached to a first cellular radiocommunications network, by indicating rapidly in a terminal of the user whether a call number designates a second mobile terminal to be called whose user is a subscriber to the first network, including if said user has taken out a prepayment card subscription, or whether said user is a subscriber to a cellular radiocommunications network other than said first network, in order to remedy the above-mentioned drawbacks.

In order to achieve this object, a method for presenting an operator indicator in a terminal of a user having a first mobile terminal attached to a first cellular radiocommunications network, said operator indicator relating to a second mobile terminal whose call number is stored in the user terminal, is characterized in that it comprises the following steps:

transmitting the call number from the user terminal to server means attached to the first network;

comparing, in the server means, said transmitted call number with call numbers of mobile terminals attached to the first network, in a first list, in order to read the operator indicator corresponding to the transmitted call number;

transmitting the operator indicator in association with the transmitted call number from the server means to the user terminal; and

in the user terminal, storing the transmitted operator indicator in correspondence with the transmitted call number, and presenting the operator indicator of the first network if said operator indicator is in a first state.

The method also makes it possible to compare, in the server means, the transmitted call number with call numbers of mobile terminals attached to at least one cellular radiocommunications network other than the first network, in a second list, in order to read a validity indicator corresponding to the transmitted call number, and in order to transmit the validity indicator in association with the operator indicator and with the transmitted call number to the user terminal, and, in the user terminal, storing the transmitted validity indicator in correspondence with the transmitted call number, and presenting the validity indicator if the operator indicator and the validity indicator are in a second state.

By taking out a subscription to a service implementing the method for the invention, determining an operator indicator of a call number enables a first user to decide to communicate with another user designated by said call number as a function of whether said other user is attached to the same network as the first user. Thus, if a user is called by an unknown mobile terminal, said user can evaluate the cost of a call back on the initiative of the user.

In addition, with development of instant messaging services accessible to mobile terminals, a user can select calls depending on preferential price rates relating to different cellular radiocommunications networks.

In addition, by means of the indicator presentation service of the invention, a user can be warned by means of the indicators being updated automatically if a call number has become invalid.

According to another characteristic of the invention, the method may further comprise the following steps:

generating an item of digital data in correspondence with the operator indicator if said operator indicator is in the first state, or with the validity indicator if said validity indicator and said operator indicator are in the second state;

transmitting the digital data with the call number and the operator and validity indicators from the server means to the user terminal;

storing the transmitted digital data in correspondence with the transmitted call number in the user terminal; and

transforming the digital data for the purpose of presenting it in the user terminal.

The invention also provides a system for presenting an operator indicator in a terminal of a user having a first mobile terminal attached to a first cellular radiocommunications network, said operator indicator relating to a second mobile terminal whose call number is stored in the user terminal;

said system being characterized in that it comprises server means attached to the first network for the purpose of comparing said call number transmitted from the user terminal with call numbers of mobile terminals attached to the first network, in a first list, in order to read the operator indicator corresponding to the transmitted call number and in order to transmit the operator indicator in association with the transmitted call number from the server means to the user terminal; and

in that the user terminal includes means for storing the transmitted operator indicator in correspondence with the transmitted call number, and means for presenting the operator indicator of the first network if said operator indicator is in a first state.

The server means may further include means for comparing said transmitted call number with call numbers of mobile terminals attached to at least one cellular radiocommunications network other than the first network, in a second list, in order to read a validity indicator corresponding to the transmitted call number, and in order to transmit the validity indicator in association with the operator indicator and with the transmitted call number to the user terminal, and the user terminal further includes means for storing the transmitted validity indicator in correspondence with the transmitted call number, and means for presenting the validity indicator if the operator indicator and the validity indicator are in a second state.

The invention also provides a portable recording medium having a microcontroller and for presenting an operator indicator in a terminal of a user having a first mobile terminal attached to a first cellular radiocommunications network, said operator indicator relating to a second mobile terminal whose call number is stored in the user terminal, said portable recording medium being characterized in that it includes:

means for transmitting the call number from the user terminal to server means attached to the first network; and

means for storing an operator indicator transmitted from the server means and in association with the transmitted call number that has been compared in the server means with call numbers of mobile terminals attached to the first network, in a first list, in order to read the operator indicator corresponding to the transmitted call number; and

means for presenting the operator indicator of the first network if said operator indicator is in a first state.

The portable recording medium having a microcontroller may further include:

means for storing a validity indicator transmitted from the server means in association with the transmitted call number, said transmitted call number having been compared in the server means with call numbers of mobile terminals attached to a cellular radiocommunications network other than the first network, in a second list, in order to read a validity indicator corresponding to the transmitted call number, and in order to transmit the validity indicator in association with the operator indicator and with the transmitted call number to the user terminal; and

means for presenting the validity indicator if the operator indicator and the validity indicator are in a second state.

Other characteristics and advantages of the present invention appear more clearly on reading the following description of preferred embodiments and implementations of the invention, given by way of non-limiting example, and with reference to the corresponding accompanying drawings, in which:

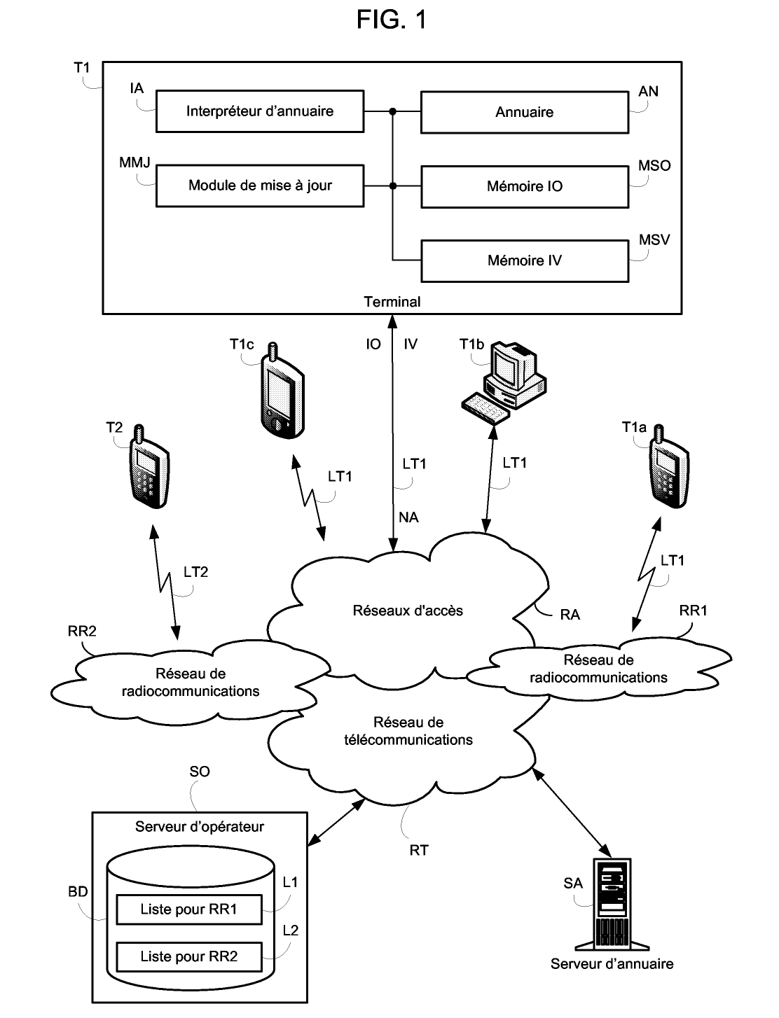

FIG. 1 is a block diagram showing a system for presenting an operator indicator in a user terminal in accordance with the invention;

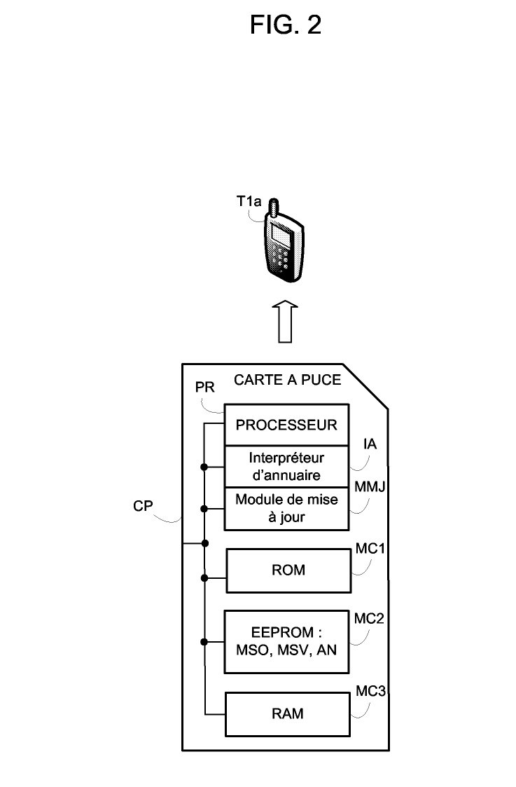

FIG. 2 is a block diagram showing a smart card for presenting an operator indicator in a user terminal in accordance with the invention;

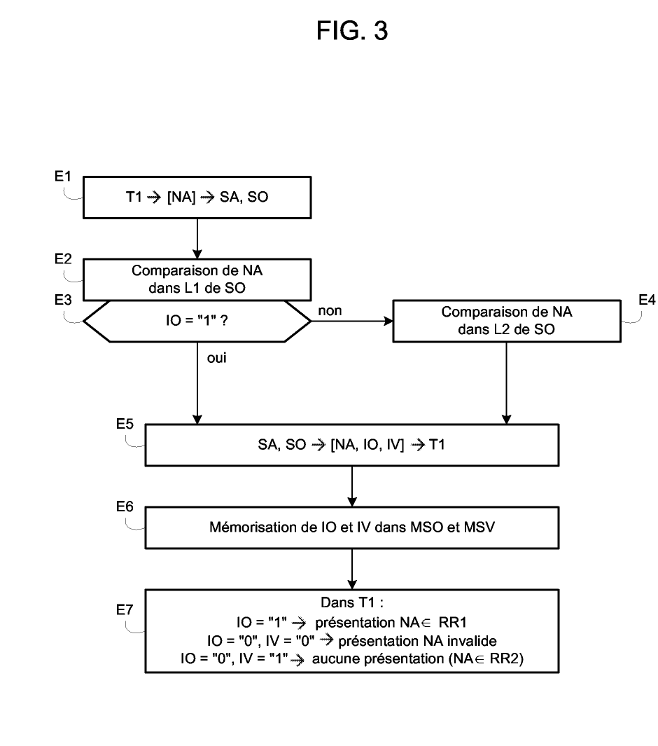

FIG. 3 is an algorithm of the main steps of a method for presenting an operator indicator in a user terminal in a first implementation of the invention; and

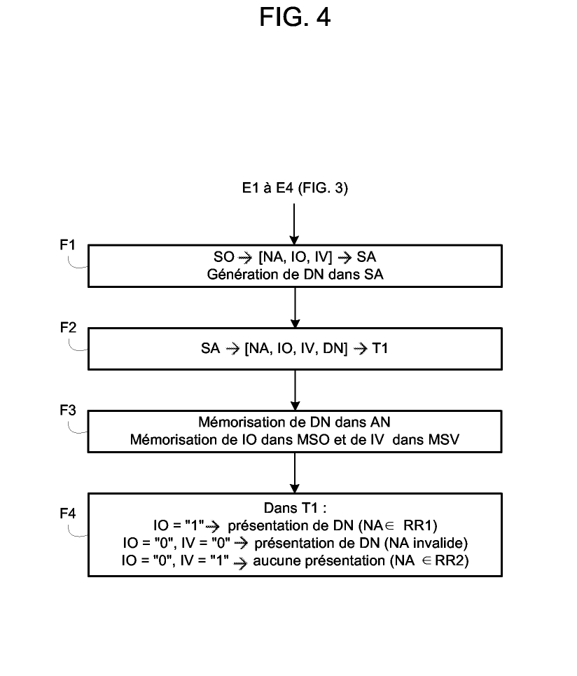

FIG. 4 is an algorithm of the main steps of a method for presenting an operator indicator in a user terminal in a second implementation of the invention.

With reference to FIG. 1, the indicator presentation system of the invention mainly comprises an operator server SO, a phonebook server SA, and a terminal T1 of a first user.

The operator server SO, as service entity of the invention, is managed by the operator of a first cellular radiocommunications network RR1 to which a first mobile terminal T1a belonging to the user is attached. The operator server SO can be connected to or incorporated in the Home Location Register (HLR) of the network RR1 that normally contains the subscription profiles of the users who are subscribers to the network RR1. A database BD in the operator server contains a first list L1 of call numbers of mobile terminals attached to the first network RR1 and a second list L2 of call numbers of mobile terminals attached to at least one cellular radiocommunications network RR2 other than the first network RR1.

The first list L1 associates the call numbers of the first network RR1 with respective ones of logic operator indicators IO. Initially when a user takes out a subscription with the operator of the first network RR1 the operator indicator IO associated with the call number of the user is put in a first state “1”.

The second list L2 associates the call numbers of the networks RR2 other than the first network RR1 with respective logic validity indicators IV. Initially, when a user takes out a subscription with the operator of a network other than the first network RR1, the validity indicator IV associated with the call number of the user is put in a first state “1”.

When a call number is allocated to no user, the operator indicator and the validity indicator that correspond to the call number are in the “0” state. The operator indicator and the validity indicator go over to the “0” state when a subscription of a user is struck off, without the user taking out another subscription with the same call number.

The database BD is consulted in order to determine whether the user of a mobile terminal T2 to be called whose call number NA is transmitted from the user terminal T1 is a subscriber to the first network RR1, or is a subscriber to another network RR2, the call number then being valid in the network RR2.

The cellular radiocommunications network RR2 corresponds to any of a plurality of cellular radiocommunications networks covering a predetermined territory.

For reasons of simplification, an “MSISDN” call number (MSISDN being an acronym for Mobile Station Integrated Services Digital Network number or for Mobile Station International Subscriber Directory Number) is considered as “belonging” to a cellular radiocommunications network when a user has taken out a subscription to that network and possesses a mobile terminal having, in particular, a removable user smart card whose International Mobile Subscriber Identity (IMSI) constant logic address includes a Mobile Subscriber Identification Number (MSIN) portion corresponding to a French “PQ MCDU” portion specific to the subscriber user, regardless of the movement of the mobile terminal or regardless of the mobile terminal containing the smart card. In which case, the mobile terminal of the user is considered to be “attached” to the cellular radiocommunications network.

The phonebook server SA is a platform that is accessible from any mobile or fixed (land line) terminal via a telecommunications network RT such as the Internet. The phonebook server SA and the user terminal T1 can exchange requests and responses, e.g. in the form of short messages (text messages) through a Short Message Service Center (SMSC). The phonebook server SA has an access gateway for communicating with the operator server SO, e.g. directly or indirectly through the Internet or through a signaling network specific to the operator of the network RR1, in order to transmit information from the operator server to the user terminal T1.

In a variant, the operator database data is distributed over a plurality of databases connected to a plurality of operator servers. In particular, the list L2 can be subdivided into lists of call numbers of mobile terminals attached to second cellular radiocommunications networks RR2 in operator servers, which lists are updated respectively by operators.

In the preferred embodiment shown in FIG. 1, in order to avoid cluttering the figure, only three terminals T1a, T1b, and T1C are shown, via which the first user can communicate with the phonebook server SA. The three terminals T1a, T1b, and T1c are all designated by reference T1 in the description below. The user terminal T1 is connected to a respective access network RA via a link LT1.

The terminal T1 is preferably the first mobile terminal T1a, the link LT1 is a radiocommunications channel, and the respective access network RA comprises the fixed network of a cellular radiocommunications network, e.g. of the Global System for Mobile communications (GSM) type with a General Packet Radio Service (GPRS), or of the Universal Mobile Telecommunications System (UMTS) type.

Similarly, the mobile terminal T2 to be called and the respective cellular radiocommunications network RR2 are interconnected via a radio link LT2.

In another example, the user terminal T1 is a personal computer (PC) or an intelligent terminal T1b connected directly by modem to the link LT1 of one of the various types of Digital Subscriber Line (xDSL) or of the Integrated Services Digital Network (ISDN) type, connected to the corresponding access network RA.

In another example, the user terminal T1 comprises a personal telecommunications electronic object or device that can, for example, be a communicating Personal Digital Assistant (PDA) T1c that can read a smart card and that can be connected to a terminal of a short-range wireless network of the Wireless Local Area Network (WLAN) type or of the type complying with one of the Standards 802.1Xx, or of a medium-range wireless network complying with the Worldwide Interoperability Microwave Access (WIMAX) Protocol.

In another example, the access network RA comprises a network for interconnecting a plurality of user terminals.

The user terminals T1 and the access networks RA are not limited to the above examples, and can be constituted by other known terminals and by other known access networks.

The user terminal T1 conventionally comprises a processor, memories, a communications interface, a display, a keypad or keyboard, and a smart card reader, and, in particular, in relation to the invention, a phonebook AN, an operator status memory MSO, a validity status memory MSV, a phonebook interpreter IA, and an update module MMJ. The phonebook AN and the memories MSO and MSV are included in non-volatile memory spaces in the terminal T1.

The phonebook AN lists the call numbers NA to be called or to be consulted from the terminal T1.

The operator status memory MSO is a non-volatile memory space for storing indicators IO relative to call numbers NA and each indicating whether the respective call number belongs to the first network RR1.

The validity status memory MSV is a non-volatile memory space for storing indicators IV relating to the call numbers NA and each indicating whether the respective call number is valid in a cellular radiocommunications network RR2 other than the first network RR1.

The above-mentioned memories MSO and MSV can be non-volatile memories that are accessible by contact or in contactless manner from the terminal T1, and/or that are included in the phonebook AN.

The phonebook interpreter IA is a user interface application that accesses the call numbers NA stored in the phonebook AN and the indicators IO and IV in the memories MSO and MSV so as to present them to the user, via the display of the terminal T1. The interpreter IA is preferably a Universal Integrated Circuit Card (UICC) application, or, in another variant, is implemented in the terminal T1 and is, for example, incorporated into the user graphics interface in the terminal T1.

The update module MMJ is an application that communicates with the phonebook server SA and updates the memories MSO and MSV by storing therein the indicators IO and IV transmitted by the phonebook server SA. Recordings of new call numbers in the phonebook AN, including modifications of call numbers that are already stored, are detected periodically, or on request from the user or from the network, by the module MMJ. The module MMJ is preferably a UICC application, or, in another variant, is implemented in the terminal T1.

In a preferred variant of the user terminal shown in FIG. 2, the terminal receives a recording medium such as a removable smart card CP, also referred to as a “microcontroller card” or as an “integrated circuit card”, operating by contact or in contactless manner, or indeed accessible from the terminal via communications means, e.g. of the infrared type.

When the terminal T1 is a mobile terminal T1a, T1c, the smart card is of the UICC type. The smart card is, for example, a Subscriber Identity Module (SIM) card for a cellular radiocommunications network of the GSM or GPRS type, or a User SIM (USIM) or a Removable User Identity Module (RUIM) for a Code Division Multiple Access (CDMA) network of the third generation (3^{rd} Generation Partnership Project (3GPP)) of the UMTS type, or of the 3GPP2 third generation of the CDMA 2000 type.

In other examples, the smart card can be a Universal Serial Bus (USB) key, a Flash-Memory Card (FMC) such as a Secure Digital Card (SDC), a Multi-Media Card (MMC), or else can be replaced by any removable portable recording medium having a microcontroller, or indeed can be accessible from the terminal via communications means, e.g. of the infrared type.

As is known, the smart card CP mainly comprises a processor PR, three memories MC1 to MC3, and an input/output port connectable to a reader of the mobile terminal for the purpose of exchanging commands and responses therewith. The memory MC1 is of the Read-only Memory (ROM) or Flash type, and includes an operating system for the card and often a virtual machine of the JavaCard type on which the operating system is based. The memory MC2 is a non-volatile memory, e.g. of the Electrically Erasable Programmable Read-Only Memory type or of the Flash type, in particular for storing characteristics of the profile of the user possessing the card, or call numbers in a phonebook. The memory MC3 is a Random Access Memory (RAM) or a Static RAM (SRAM) serving more particularly to process data to be exchanged between the processor PR and a microcontroller included in the mobile terminal T1a.

In this variant, the update module MMJ and the phonebook interpreter IA are hard-implemented in or in communication with the processor PR of the smart card CP. In a variant, the update module MMJ and the phonebook interpreter IA are included in software form in the ROM MC1. The processor PR of the card CP executes most of the steps of the method for the invention for presenting an operator indicator as described above with reference to the terminal T1a. Two spaces in the non-volatile memory MC2 of the card are reserved respectively for the memories MSO and MSV of the terminal of the first embodiment shown in FIG. 1, and are dedicated to storing the indicators IO and IV. A third space in the non-volatile memory MC2 of the card is reserved for the phonebook AN.

In a first implementation shown in FIG. 3, the method for presenting an operator indicator in a user terminal T1 comprises steps E1 to E7 executed in the operator indicator presentation system of the invention.

In step E1, the update module MMJ performs the following preliminary steps. Initially, the module MMJ requests a communication to be set up with the phonebook server AN via the communications interface of the user terminal T1 with which it is associated. This communication can be requested on the initiative of the user, or automatically at each period of call number monitoring during which at least one new call number has been recorded in the phonebook AN, or automatically on the initiative of the operator from the server SA or from any other server, or, for example, systematically at the beginning of a call procedure but prior to setting up the call. However, the communication can be requested autonomously, e.g. as soon as the module MMJ detects a new call number dialed by the user and recorded in the phonebook AN. Then, the module MMJ reads, from the phonebook AN, the call number NA that is identical to an MSISDN (Mobile Station International Subscriber Directory Number) for an entry in the phonebook AN conventionally corresponding, for example, to the name of the user associated with the call number NA. The module MMJ then transmits the call number NA to the phonebook server SA, and that number is then transmitted on to the operator server SO.

Instep E2, in response to the transmitted call number NA, the operator server SO compares said transmitted call number with the call numbers in the first list L1 corresponding to mobile terminals T2 attached to the first network RR1.

If the transmitted call number is included in the first list L1, the operator server SO reads the state of the operator indicator IO associated with the transmitted call number NA, in step E3.

If the operator indicator IO is in the “0” state, the operator server SO compares said transmitted call number NA with the call numbers in the second list L2 corresponding to mobile terminals T2 attached to a network RR2 other than the first network RR1, in step E4. If the transmitted call number is included in the second list L2, the operator server SO reads the validity indicator IV corresponding to the transmitted call number NA.

In step E3, if the operator indicator IO is in the “1” state, it is not necessary to perform the comparison in the second list, and the validity indictor IV automatically takes the value “0”. Thus, when the operator indictor IO is in the first state “1”, the validity indicator IV must be in the second state “0”, and when the operator indicator IO is in the second state “0”, the validity indicator IV can be in the first state “0” or the second state “1”. A mobile terminal T2 is attached either to the first network RR1 or to a network RR2. When the operator indicator IO and the validity indicator IV are in the second state, the mobile terminal T2 is not attached to any cellular radiocommunications network and the corresponding call number is invalid.

In step E5, the operator server SO transmits the operator indictor IO and the validity indicator IV in association with the call number NA to the phonebook server SA which transmits them on to the update module MMJ of the terminal T1.

In step E6, the update module MMJ writes the operator indicator IO and the validity indicator IV that are transmitted from the phonebook server in correspondence with the transmitted call number NA respectively in the operator status memory MSO and in the validity status memory MSV.

In step E7, the phonebook interpreter IA generates presentation of the operator indicator IO or of the validity indicator IV on the display of the terminal T1, every time the user uses a function for reading the call number NA, or for reading a parameter, such as name, of the user to whom the call number NA is allocated. For this purpose, the phonebook interpreter IA analyses, for the entry in the phonebook AN that corresponds to the call number NA, the operator indicator IO and the validity indicator IV respectively in the operator status memory MSO and in the validity status memory MSV. The phonebook interpreter IA then presents the indicator IO to the user in order to inform the user that the call number NA stored in the phonebook AN of the terminal T1 belongs to the first network RR1, when the operator indictor IO is in the first state “1”. Otherwise, the phonebook interpreter IA presents the indicator IV, in the form of a predetermined sign or of a worded message such as “number unallocated” or “number unattainable”, indicating that the call number does not belong to any cellular radiocommunications network and is thus invalid, when the operator indicator IO and the validity indicator IV are in the second state “0”. In which case, the interpreter and/or the update module MMJ can propose to the user to delete the unallocated call number from the phonebook. When the operator indictor IO is in the second state “0” and the validity indicator IV is in the first state “1”, the phonebook interpreter IA does not present any indicator, which means that the call number belongs to a network RR2.

Preferably, the “1” state of the indicator IO and the combination of the “0” states of the indicators IO and IV are transformed by the interpreter IA into respective icons or colors presented on the display of the terminal T1, and/or into respective synthesized words reproduced by a loudspeaker of the terminal. In addition, this presentation can take place optionally when the user wishes to personalize access to this information, or automatically when a particular event is detected, e.g. when a “subscription exceeded” or “not included in the subscription” signal is transmitted by the network to the terminal.

In a variant, the user terminal T1 is the same terminal as the first mobile terminal T1a which itself presents transformed operator and validity indicators.

In a second implementation shown in FIG. 4, the user terminal T1 also receives an item of digital data DN from the server means SA, SO, which item of digital data establishes presentation of the operator indicator IO or of the validity indicator IV, in the steps F1 to F4 supplementing the method for presenting an operator indicator of the invention, and also executed automatically in the indicator presentation system.

The phonebook server SA receives the operator indicator IO and the validity indicator IV from the operator server, and analyzes the indicators transmitted and determined previously in steps E2 to E4.

In step F1, the phonebook server, having received the operator and validity indicators IO and IV, directly generates an item of digital data DN contributing to establishing presentation of the operator indicator in correspondence with the operator indicator IO if said operator indicator is in the first state “1”, or with the validity indicator IV if said validity indicator and the operator indicator are in the second state “0”.

Then the steps E5 to E7 are replaced with the steps F2 to F4. In step F2, the phonebook server SA transmits the digital data DN with the call number NA and operator and validity indicators IO and IV to the update module MMJ of the terminal T1. In step F3, the update module MMJ stores the digital data DN in the phonebook AN in correspondence with the transmitted call number NA, at the same time as it stores the operator and validity indicators IO and IV in the memories MSO and MSV. In step F4, the phonebook interpreter IA directly analyses the entry in the phonebook AN that corresponds to the call number NA so as to present the call number in association with a visual transformation and/or audio transformation of the digital data DN transmitted from the phonebook server, in a manner analogous to the above-described presentations of indicators.

The invention described herein relates to a method and to a system for presenting, in particular, an operator indicator IO corresponding to each call number stored in the user terminal T1. In a preferred implementation, the steps of the method are determined by the instructions of a computer program incorporated in a device such as a terminal T1 of a user or such as a portable recording medium having a microcontroller, such as a smart card, in communication with a terminal of a user, the user having a first mobile terminal T1a attached to a first cellular radiocommunications network RR1, and the program being designed to present an operator indicator IO in the user terminal, said operator indicator IO relating to a second mobile terminal T2 whose call number is stored in the user terminal T1. The program comprises program instructions which, when said program is loaded and executed in the device whose operation is then controlled by executing the program, perform the steps of the method for the invention for presenting an indicator.

1. A method for presenting an operator indicator in a terminal of a user having a first mobile terminal attached to a first cellular radiocommunications network, said operator indicator relating to a second mobile terminal whose call number is stored in the user terminal, said method comprising the following steps:
transmitting the call number from the user terminal to a server attached to the first network;
comparing, in the server, said transmitted call number with call numbers of mobile terminals attached to the first network, stored in a first list, in order to read an operator indicator corresponding to the transmitted call number;
transmitting the operator indicator in association with the transmitted call number from the server to the user terminal; and
in the user terminal, storing the transmitted operator indicator in correspondence with the transmitted call number, and presenting the operator indicator of the first network if said operator indicator is in a first state.

2. A method according to claim 1, further comprising the steps of comparing, in the server, the transmitted call number with call numbers of mobile terminals attached to at least one cellular radiocommunications network other than the first network, stored in a second list, in order to read a validity indicator corresponding to the transmitted call number, transmitting the validity indicator in association with the operator indicator and with the transmitted call number to the user terminal, and, in the user terminal, storing the transmitted validity indicator in correspondence with the transmitted call number, and presenting the validity indicator if the operator indicator and the validity indicator are in a second state.

3. A method according to claim 2, further comprising the following steps:
generating an item of digital data in correspondence with the operator indicator if said operator indicator is in the first state, or with the validity indicator if said validity indicator and said operator indicator are in the second state;
transmitting the digital data with the call number and the operator and validity indicators from the server to the user terminal;
storing the transmitted digital data in correspondence with the transmitted call number in the user terminal; and
transforming the digital data for the purpose of presenting it in the user terminal.

4. A system for presenting an operator indicator in a terminal of a user having a first mobile terminal attached to a first cellular radiocommunications network, said operator indicator relating to a second mobile terminal whose call number is stored in the user terminal;
said system comprising a server attached to the first network which operates to compare a call number transmitted from the user terminal with call numbers of mobile terminals attached to the first network, stored in a first list, in order to read an operator indicator corresponding to the transmitted call number and to transmit the operator indicator in association with the transmitted call number (NA) from the server to the user terminal; and
wherein the user terminal includes a memory for storing the transmitted operator indicator in correspondence with the transmitted call number, and an interface for presenting the operator indicator of the first network if said operator indicator is in a first state.

5. A system according to claim 4, in which the server further includes means for comparing said transmitted call number with call numbers of mobile terminals attached to at least one cellular radiocommunications network other than the first network, stored in a second list, in order to read a validity indicator corresponding to the transmitted call number, and to transmit the validity indicator in association with the operator indicator and with the transmitted call number to the user terminal, and the user terminal further includes a memory for storing the transmitted validity indicator in correspondence with the transmitted call number, and wherein said interface presents the validity indicator if the operator indicator and the validity indicator are in a second state.

6. A system according to claim 4, in which the user terminal is the same terminal as the first mobile terminal.

7. A portable recording medium having a microcontroller, for presenting an operator indicator in a terminal of a user having a first mobile terminal attached to a first cellular radiocommunications network, said operator indicator relating to a second mobile terminal whose call number is stored in the user terminal, said portable recording medium comprising:
an application for transmitting the call number from the user terminal to a server attached to the first network; and
a memory storing an operator indicator transmitted from the server and in association with the transmitted call number that has been compared in the server with call numbers of mobile terminals attached to the first network, stored in a first list, in order to read the operator indicator corresponding to the transmitted call number; and
an interface for presenting the operator indicator of the first network if said operator indicator is in a first state.

8. A portable recording medium having a microcontroller according to claim 7, further including:
a memory storing a validity indicator transmitted from the server in association with the transmitted call number, said transmitted call number having been compared in the server with call numbers of mobile terminals attached to a cellular radiocommunications network other than the first network, stored in a second list, in order to read a validity indicator corresponding to the transmitted call number, and in order to transmit the validity indicator in association with the operator indicator and with the transmitted call number to the user terminal; and
wherein said interface presents the validity indicator if the operator indicator and the validity indicator are in a second state.

9. A computer program implemented in a portable recording medium, which portable recording medium is configured for communication with a terminal of a user having a first mobile terminal attached to a first cellular radiocommunications network, the program causing said terminal to present an operator indicator in the user terminal, said operator indicator relating to a second mobile terminal whose call number is stored in the user terminal, said program comprising program instructions which, when said program is loaded and executed in a device whose operation is controlled by executing the program, perform the following steps:
transmitting the call number from the user terminal to a server attached to the first network;
storing an operator indicator transmitted from the server in association with the transmitted call number, said transmitted call number having been compared in the server with call numbers of mobile terminals attached to the first network, stored in a first list, in order to read the operator indicator corresponding to the transmitted call number; and
presenting the operator indicator of the first network if said operator indicator is in a first state.

10. A computer program implemented in a portable recording medium according to claim 9, further comprising the program instructions for performing the following steps:
storing a validity indictor transmitted from the server in association with the transmitted call number, said transmitted call number having been compared in the server with call numbers of mobile terminals attached to a cellular radiocommunications network other than the first network, stored in a second list, in order to read the validity indicator corresponding to the transmitted call number and in order to transmit the validity indicator in association with the operator indicator and with the transmitted call number to the user terminal; and
presenting the validity indicator if the operator indicator and the validity indicator are in a second state.

11. A system according to claim 5, in which the user terminal is the same terminal as the first mobile terminal.
